(19) United States
(12) Patent Application Publication
(10) Pub. No.: US 2026/0141740 A1
(43) Pub. Date: May 21, 2026

(54) METHOD FOR GENERATING CAPTION INFORMATION FOR MEDIA CONTENT, DEVICE, AND MEDIUM

(71) Applicant: Beijing Zitiao Network Technology Co., Ltd., Beijing (CN)

(72) Inventors: Linxi YE, Beijing (CN); Junliang LU, Beijing (CN); Zenghui WANG, Beijing (CN); Xu LI, Beijing (CN); Siming CHEN, Beijing (CN); Shuzhan YUAN, Beijing (CN)

(21) Appl. No.: 19/394,671

(22) Filed: Nov. 19, 2025

(30) Foreign Application Priority Data
Nov. 20, 2024 (CN) 202411670150.3

(51) Int. Cl. G06V 20/70; G06F 3/04817; G06F 40/103

(52) U.S. Cl. CPC G06V 20/70; G06F 3/04817; G06F 40/103

(57) ABSTRACT

The embodiments of the present disclosure provide a method for generating caption information for media content, device and medium. The method includes: presenting, in response to a triggering operation on media content in a media content editing page, triggered second media content in the media content editing page and a caption editing panel in the media content editing page; generating, in response to a triggering operation on a first control in the caption editing panel, first caption information associated with the media content based on content information edited in the caption editing panel; presenting the media content and the first caption information in the media content editing page.

### CROSS-REFERENCE TO RELATED APPLICATION

This application claims the priority to and benefits of the Chinese Patent Application, No. 202411670150.3, which was filed on Nov. 20, 2024. The aforementioned patent application is hereby incorporated by reference in its entirety.

### TECHNICAL FIELD

The embodiments of the present disclosure relate to the field of information processing technology, and more particularly, to a method and apparatus for generating caption information for media content, device, and medium.

### BACKGROUND

With the development of information technology, in internet-based social contexts, more and more people share their daily lives by posting pictures or videos. In order to improve the richness and intelligibility of shared content, appropriate descriptive text is generally attached to the pictures and videos. At present, adding the corresponding description text for pictures and videos requires the user to write, which is time-consuming, lack of the ability to render the content and low quality of writing, thus one cannot effectively attract the attention of other users, and the other is to reduce the user's enthusiasm to share the pictures or videos, thus affecting the user's interactive experience.

### SUMMARY

The present disclosure provides a method and apparatus for generating caption information for media content, device, and medium, so as to automatically generate high-quality captions, improve the efficiency of caption generation, meet users'multiple needs for the relevance and expressiveness of caption content, and enhance users'enthusiasm for interaction.

In a first aspect, embodiments of the present disclosure provides a method for generating caption information for media content, and the method includes: presenting, in response to a triggering operation on media content in a media content editing page, triggered target media content (e.g. second media content) in the media content editing page and a caption editing panel in the media content editing page; generating, in response to a triggering operation on a target control (e.g. a first control) in the caption editing panel, target caption information associated with the media content based on content information edited in the caption editing panel; and presenting the media content and the target caption information (e.g. first caption information) in the media content editing page.

In a second aspect, the present disclosure provides an apparatus for generating caption information for media content, and the apparatus includes: a caption panel presentation module, configured to present, in response to a triggering operation on media content in a media content editing page, triggered target media content in the media content editing page and a caption editing panel in the media content editing page; a target caption determination module, configured to generate, in response to a triggering operation on a target control in the caption editing panel, target caption information associated with the media content based on content information edited in the caption editing panel; and a presentation module, configured to present the media content and the target caption information in the media content editing page.

In a third aspect, the present disclosure provides an electronic device, and the electronic device includes: one or more processors; and a storage apparatus, for storing one or more programs, the one or more programs are performed by the one or more processors, cause the one or more processors to perform a method for generating caption information for media content according to any one of the embodiments of the present disclosure.

In a fourth aspect, the present disclosure provides a non-transitory computer-readable storage medium comprising computer-executable instructions, where the computer-executable instructions, when performed by a computer processor, are configured to perform a method for generating caption information for media content according to any one of the embodiments of the present disclosure.

A technical solution of an embodiment of the present disclosure, in response to a triggering operation on media content in a media content editing page, presenting triggered target media content in the media content editing page and a caption editing panel in the media content editing page; generating, in response to a triggering operation on a target control in the caption editing panel, target caption information associated with the media content based on the content information edited in the caption editing panel; and presenting the media content and corresponding target caption information in the media content editing page. In the technical solution of the embodiments of the present disclosure, a user can quickly edit content information satisfying personalized requirements via a caption editing panel, thereby automatically generating a high-quality caption, improving the efficiency of caption generation, satisfying multiple requirements of a user on the fit degree and expressiveness of the caption content, and improving the user's interaction enthusiasm.

### BRIEF DESCRIPTION OF DRAWINGS

The above and other features, advantages and aspects of various embodiments of the present disclosure will become more apparent when taken in conjunction with the accompanying drawings and with reference to the following detailed implementations. Throughout the drawings, the same or similar reference signs denote the same or similar elements. It should be understood that the drawings are schematic, and the components and elements are not necessarily drawn to scale.

FIG. 1 is a schematic flow diagram of a method for generating caption information for media content according to an embodiment of the present disclosure;

FIG. 2 is a schematic diagram illustrating a presentation process of target media content and a caption editing panel in a media content editing page according to an embodiment of the present disclosure;

FIG. 3 is a schematic diagram illustrating a generation process of target caption information according to an embodiment of the present disclosure;

FIG. 4 is a schematic diagram illustrating a presentation process of guidance prompt information according to an embodiment of the present disclosure;

FIG. 5 is a schematic flow diagram of another method for generating caption information for media content according to an embodiment of the present disclosure;

FIG. 6 is a schematic diagram illustrating a generation process of a customized caption theme according to an embodiment of the present disclosure;

FIG. 7 is a schematic flow diagram of another method for generating caption information for media content according to an embodiment of the present disclosure;

FIG. 8 is a schematic diagram of a media presentation record in a media record presentation interface according to an embodiment of the present disclosure;

FIG. 9 is a schematic presentation diagram of a plurality of media presentation records in a media record presentation interface according to an embodiment of the present disclosure;

FIG. 10 is a schematic flow diagram of yet another method for generating caption information for media content according to an embodiment of the present disclosure;

FIG. 11 is a schematic diagram illustrating a presentation process of target caption information corresponding to a first media content according to an embodiment of the present disclosure;

FIG. 12 is a schematic diagram illustrating a media content presentation track and a corresponding text track according to an embodiment of the present disclosure;

FIG. 13 is a schematic process diagram for presenting target caption information in a second presentation form according to an embodiment of the present disclosure;

FIG. 14 is a schematic diagram of an apparatus for generating caption information for media content according to an embodiment of the present disclosure;

FIG. 15 is a schematic diagram of an electronic device according to an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein. On the contrary, these embodiments are provided to enable a more thorough and complete understanding of the present disclosure. It should be understood that the drawings and embodiments of the present disclosure are for illustrative purposes only and are not intended to limit the protection scope of the present disclosure.

It should be understood that the various steps described in the method embodiments of the present disclosure may be executed at least one of in different orders or in parallel. In addition, method embodiments may at least one of include additional steps or omit the execution of the shown steps. The scope of the present disclosure is not limited in this regard.

As used herein, the term “including” and its variants are open-ended, meaning “including but not limited to”. The term “based on” means “at least partially based on”. The term “one embodiment” means “at least one embodiment”; the term “another embodiment” means “at least one additional embodiment”; the term “some embodiments” means “at least some embodiments”. Relevant definitions of other terms will be given in the following description.

It should be noted that the concepts such as “first” and “second” mentioned in the present disclosure are only used to distinguish different devices, modules or units, and are not used to limit the order of functions executed by these devices, modules or units or their interdependencies.

It should be noted that the modifications of “one” and “plurality” mentioned in the present disclosure are illustrative rather than restrictive, and those skilled in the art should understand that they should be interpreted as “one or more” unless clearly indicated otherwise in the context.

The names of messages or information interacted between multiple devices in the embodiments of the present disclosure are only for illustrative purposes, and are not used to limit the scope of these messages or information.

It can be understood that before using the technical solutions disclosed in the embodiments of the present disclosure, the user should be informed of the type, scope of use, usage scenarios, etc. of the personal information involved in the present disclosure through appropriate means in accordance with relevant laws and regulations, and the user's authorization should be obtained.

For example, in response to receiving an active request from the user, prompt information is sent to the user to clearly remind the user that the operation he requests to perform will require the acquisition and use of the user's personal information. Thus, the user can independently choose whether to provide personal information to software or hardware such as electronic devices, applications, servers or storage media that perform the operations of the technical solutions of the present disclosure according to the prompt information.

As an optional but non-limiting implementation, in response to receiving an active request from the user, the way of sending prompt information to the user may be, for example, a pop-up window, in which the prompt information may be presented in text. In addition, the pop-up window may also carry selection controls for the user to choose “agree” or “disagree” to provide personal information to the electronic device.

It can be understood that the above process of notifying and obtaining user authorization is only illustrative and does not limit the implementation of the present disclosure. Other ways that meet relevant laws and regulations can also be applied to the implementation of the present disclosure.

It can be understood that the data involved in the technical solution (including but not limited to the data itself, the acquisition or use of data) should comply with the requirements of corresponding laws, regulations and relevant provisions.

Before the present solution is introduced, an application scenario may be exemplified. This technical solution can be applied in a scenario in which it is necessary to add caption information to authored content. Caption information refers to text added to the content authored by the user. The text may be a spoken descriptive text, or may be a text which has been subjected to a polishing process, for example, the text after the polishing may be a poem, an aesthetic sentence, etc. For example, when making a short video to be shared in a media content editing program, the method of the present embodiment can be used to automatically add caption information to some of the material prepared by a user.

Illustratively, in the current social media environment, the quality and style of the caption information are critical to the attractiveness and interactivity of the content as the user shares the content. However, in the existing artificial captioning creation means, users often spend a lot of time in writing the caption, especially in the pursuit of creativity and personalized expression, this time-consuming process reduces the convenience of sharing, and has the problem of low efficiency of composition; in addition, due to the differences in the user's writing level and style, the quality of the generated caption is uneven, and there is no guarantee that every content can effectively attract the attention of the audience. The caption information generated based on the fixed text format cannot be adjusted according to different creative needs and visual style, which leads to a lack of content expressiveness.

According to the technical solution provided by the embodiments of the present invention, a user can edit content information via a caption editing panel, thereby automatically generating a high-quality document and providing a personalized selection, so as to satisfy the user's dual requirements of efficiency, quality, and diversity.

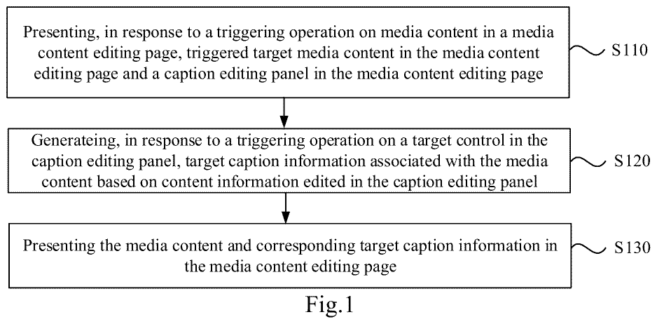

FIG. 1 is a schematic flow diagram of a method for generating caption information for media content according to an embodiment of the present disclosure, the embodiment of the present disclosure is applicable to any scenario in which caption information needs to be added for authored contents, and the method can be performed by a media content generating caption information apparatus, and the apparatus can be implemented in the form of at least one of software or hardware, and can optionally be implemented by an electronic device, and the electronic device can be a mobile terminal, a PC end or a server, etc.

As shown in FIG. 1, the method of the present embodiment may specifically include:
S110, presenting, in response to a triggering operation on media content in a media content editing page, triggered target media content in the media content editing page and a caption editing panel in the media content editing page.

The media content editing page refers to a presentation interface for editing and managing media content. The media content refers to interactive content to be shared, which can be presented on a multimedia display device, and optionally, the media content can be at least one of media materials such as text, pictures, and videos. The target media content is media content that is triggered to be selected by the user. The caption editing panel refers to the interface used to generate, edit, and adjust the captions. Caption refers to textual content that describes or explains the content of a media content, such as a picture or a video, when it is distributed on a social media or Internet platform.

In particular, the method for generating caption information for media content provided by an embodiment of the present invention may be integrated into any target application having media content editing and presentation function. After a user triggers a preset control corresponding to a target application program, the first page of the target application program can be entered, and at this time, the target user can trigger a media content editing control on the first page, so that a media content editing page can be presented in the current page. The media content in the media content editing page can include two acquisition approaches: on the one hand, the media content can be an picture or video photographed in real time; when a user triggers a camera control of a camera apparatus, a camera apparatus integrated in a mobile terminal is invoked at this moment, and an picture or video corresponding to the environment is photographed by the camera apparatus, and the picture or video generated at this moment is the media content. On the other hand, the media content may be a pre-captured picture or video, which is transferred to the media content editing page as the media content through the upper transfer port of the target application. When the user triggers any picture or any piece of video on the media content editing page, the triggered media content is the target media content. This target media content may then be presented in a media content editing page. The media content editing page also includes a preset caption generation control, and when a user triggers the caption generation control, a caption editing panel can be presented in the media content editing page. A caption editing operation is performed in a caption editing panel to generate caption information corresponding to the media content.

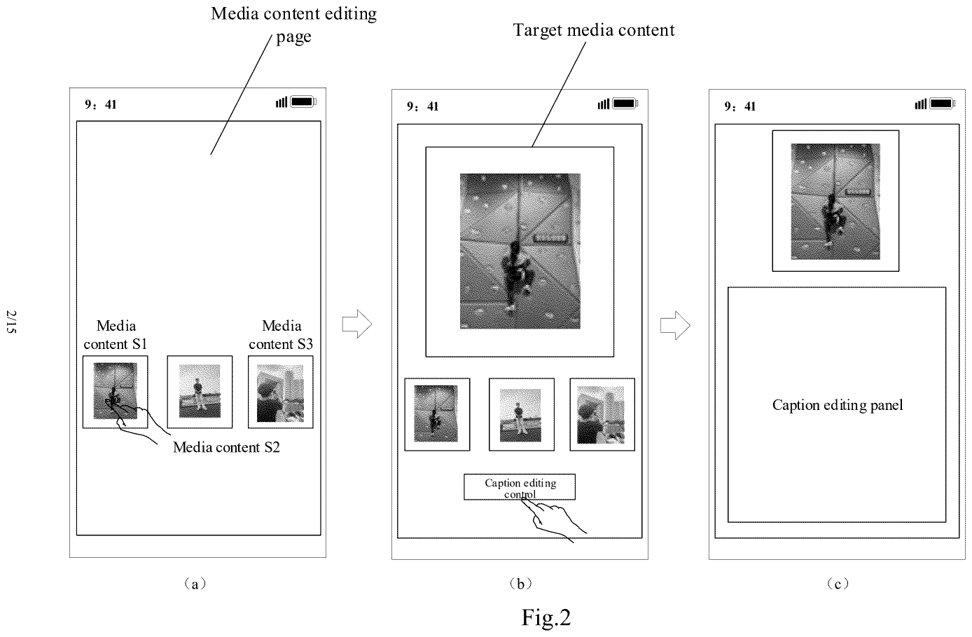

Illustratively, see FIG. 2 for a schematic diagram of the presentation process of a target media content and a caption editing panel in a media content editing page. As shown in FIG. 2(a), a media content editing page includes a media content S1, a media content S2 and a media content S3; when a user triggers the media content S1, the media content S1 is a target media content at this time, and the media content S1 can be presented in the media content editing page, as shown in FIG. 2(b). When the user triggers the caption editing control, the caption editing panel may be presented in the media content editing page at this point, as shown in FIG. 2(c).
S120, generating, in response to a triggering operation on a target control in the caption editing panel, target caption information associated with the media content based on the content information edited in the caption editing panel.

In the present embodiment, a plurality of preset controls are included in the caption editing panel, and different controls correspond to different caption constraint information. Target controls are preset controls that are triggered by the user in the caption editing panel.

Content information refers to constraint information that needs to be followed when generating caption information, so as to generate caption information with a high degree of fit with media content. In other words, the content information plays a role of a constraint, and the target caption information needs to be generated according to the content information. For example, the content information may include, but is not limited to, at least one of key words, specified topics, or specified styles, among other content. The target caption information is the automatically generated text description or explanation. The amount of target caption information may correspond to the amount of media content.

Specifically, the caption editing panel includes at least one preset control. A user can trigger or edit one or more preset controls in the caption editing panel, and these triggered or edited preset controls are target controls, and corresponding content information can be generated by operating these target controls. Thus, the target caption information associated with the media content may be automatically generated based on the content information. For example, the target caption information may be generated based on a large language model, with the content information serving as a retrieval condition. In the process of generating target caption information associated with the media content, a caption editing panel may be closed, and generation progress information about the generated target caption information is presented in a presentation area corresponding to the caption editing panel.

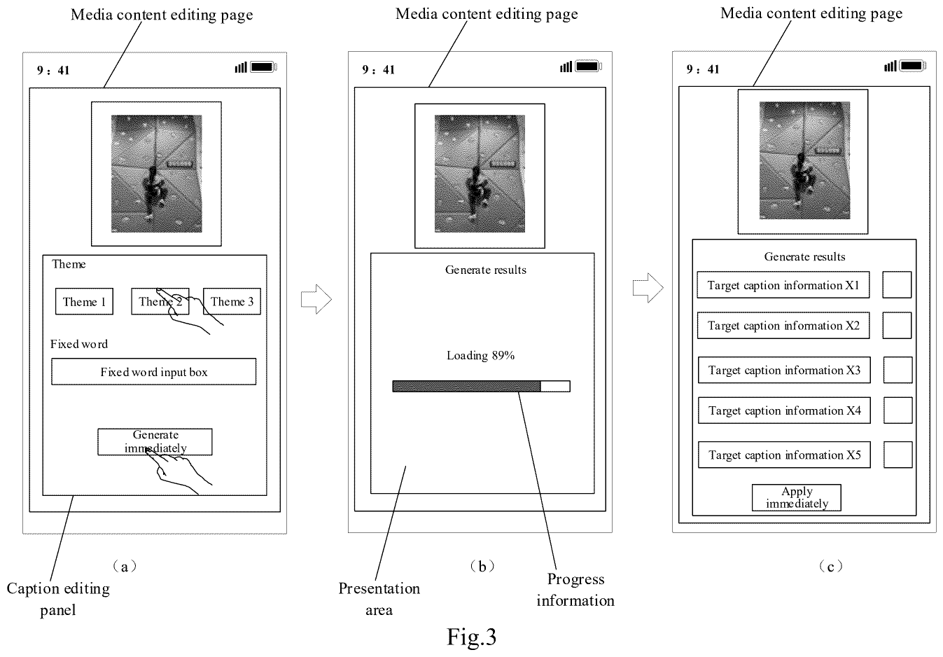

Illustratively, see FIG. 3 for a schematic diagram of a generation process of target caption information. As shown in FIG. 3(a), the preset controls in the caption editing panel include: a theme 1 control, a theme 2 control and a theme 3 control corresponding to different themes, where the theme is configured to characterize a style of target caption information corresponding to the media content; an input box of fixed words can be input, and the user can edit the target word in the input box, and the target word will appear in the target caption information finally generated. When the user clicks the control of “theme 2” in the caption editing panel in FIG. 3(a), enters the word “street” in the fixed word input box, and then clicks the control of “generate immediately”, the caption editing panel can be closed, and the generation progress information of the generated target caption information is presented in the presentation area, where the generation progress information is represented as the presentationtext “loading 89%” and a progress bar, as shown in FIG. 3(b).

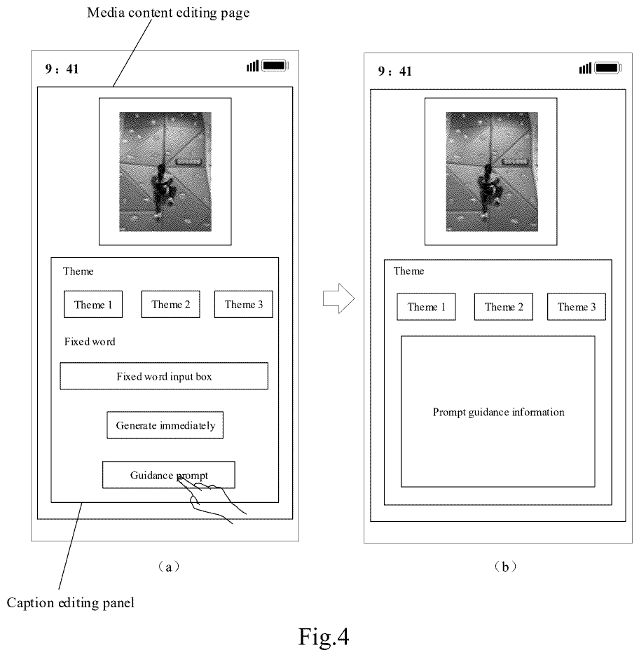

In particular, a guidance prompt control corresponding to a current operation page can be preset in an operation page of each step of generating target caption information, and when it is detected that the guidance prompt teaching control is triggered, guidance prompt information can be presented, where the guidance prompt information is configured to characterize a specific operation method of the current step. Illustratively, see FIG. 4 for a schematic diagram of the presentation process of guidance prompt information, as shown in FIG. 4(a), if the user triggers the “guidance prompt” control, the prompt guidance information of the current operation step as shown in FIG. 4(b) can be presented.
S130, presenting the media content and corresponding target caption information in the media content editing page.

In the present embodiment, when the generation process of the target caption information is completed, that is, when the generation progress information of the target caption information is 100%, the media content and the generated one or more target caption information can be presented in the media content editing page. With continuing reference to FIG. 3 for the schematic diagram for presenting the target caption information, as shown in FIG. 3(c), when the loading of the target caption information is completed, that is, when the progress information is 100%, the media content and each generated target caption information can be presented in the presentation area.

In particular, when an operation of triggering the generation of the caption information corresponding to the media content is detected, the pop-up window may prompt whether to regenerate the target caption information, and when the user clicks on the confirmation information, the target caption information corresponding to the media content may be regenerated.

A technical solution of an embodiment of the present disclosure, in response to a triggering operation on media content in a media content editing page, presenting triggered target media content in the media content editing page and a caption editing panel in the media content editing page; generating, in response to a triggering operation on a target control in the caption editing panel, target caption information associated with the media content based on the content information edited in the caption editing panel; and presenting the media content and corresponding target caption information in the media content editing page. In the technical solution of the embodiments of the present disclosure, a user can quickly edit content information satisfying personalized requirements via a caption editing panel, thereby automatically generating a high-quality caption, improving the efficiency of caption generation, satisfying multiple requirements of a user on the fit degree and expressiveness of the caption content, and improving the user's interaction enthusiasm.

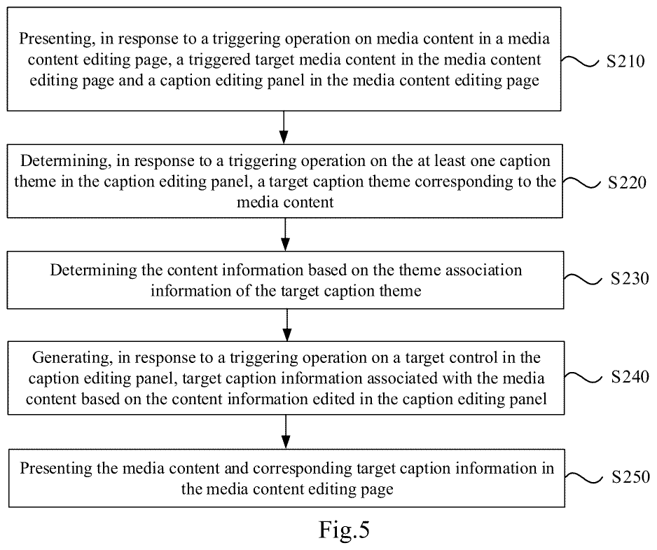

FIG. 5 is a schematic flow diagram of another method for generating caption information for media content according to an embodiment of the present disclosure. On the basis of the above-mentioned embodiments, a caption editing panel in technical solution of the present embodiment includes at least one caption theme, a target caption theme (e.g. first caption theme) corresponding to a media content is determined in response to a triggering operation on the at least one caption theme in a caption editing panel, and content information is determined based on theme association information of the target caption theme, and the specific embodiments thereof can be seen from the detailed description of the embodiments of the present disclosure. The same or similar technical features as those of the previous embodiments will not be described in detail.

As shown in FIG. 5, the method of the present embodiment may specifically include:
S210, presenting, in response to a triggering operation on a media content in a media content editing page, triggered target media content in the media content editing page and a caption editing panel in the media content editing page.

In the present embodiment, at least one caption theme is included in the caption editing panel, where the caption theme is configured to characterize a style of target caption information corresponding to the media content. For example, the caption themes may include: scene caption theme, character caption theme, food caption theme, general caption theme, retro caption theme, etc.
S220, determining, in response to a triggering operation on the at least one caption theme in the caption editing panel, a target caption theme corresponding to the media content.

The target caption theme is a caption theme selected by a user.

In this embodiment, when a user clicks on one or more of the caption themes in the caption editing panel, these triggered caption themes are the target caption themes corresponding to the media content.
S230, determining the content information based on the theme association information about the target caption theme.

The theme association information refers to relevant information that is more detailed or personalized on the premise that the target caption theme is the first constraint content. For example, the theme association information may be a fixed word, a fixed sentence, etc., edited by the user.

In the present embodiment, a fixed word description control may also be included in a caption editing panel, and when a user selects a certain target caption theme, a fixed word sentence corresponding to the target caption theme can be obtained by editing the fixed word description control, and the fixed word sentence is theme association information of the target caption theme. Thus, the target caption theme and the theme association information may be taken together as the content information. The purpose of this setting is to improve the richness of caption information by setting a variety of optional topics and more detailed theme association information, which can automatically generate a corresponding style of caption for a specific scene (e.g. delicacy, landscape, etc.), ensuring that each topic has a high degree of fit with the visual content, thus improving the richness of content information.

On the basis of the above-mentioned embodiments, at least one of the caption themes includes a customized caption theme. The specific implementation method for determining content information based on the theme association information about the target caption theme also includes: in response to a triggering operation on a customized caption theme in a caption editing panel, a fixed word description control and a caption style editing control are presented in the caption editing panel; the theme association information edited in at least one of the fixed word description control or the caption style editing control is used as the content information.

The customized caption theme is a caption theme for which the user can automatically define and edit the caption style. Fixed word description control refers to a control for carrying a fixed word edited by a user. A fixed word edited in the fixed word description control is the word that needs to be included in generating the target caption information. A caption style editing control refers to a control for carrying a style description statement edited by a user. The style description statement edited in the caption style editing control is the language style that needs to be followed to generate the target caption information. In particular, the fixed word description control and the caption style editing control may be in the control format of a text input box.

In the present embodiment, a customized caption theme is also included in the caption theme. The user can edit at least one of a fixed word or style description sentence through a fixed word description control under a customized caption theme and a caption style editing control, so that the customized text content edited by the user can be taken as content information. By customizing the caption information generated by the text content, the user can flexibly select and modify the text constraint information, so that the user can quickly generate high-quality text consistent with the selected theme style when using these themes. This method not only improves the efficiency of content creation but also enhances the attractiveness and personalized expression of the content, and ultimately improves the user's participation and interaction in social media.

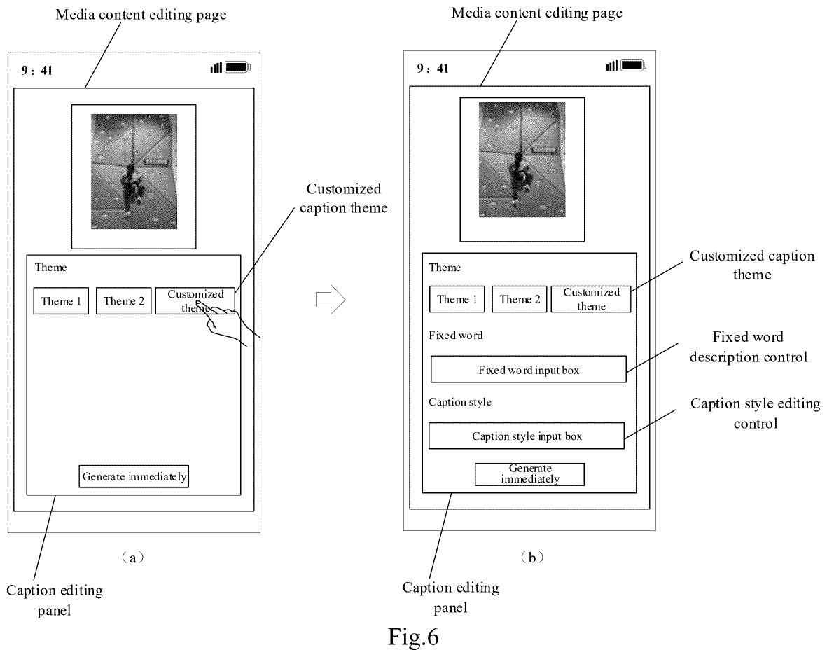

Illustratively, see FIG. 6 for a schematic diagram of the generation process of the customized caption theme. As shown in FIG. 6(a), the preset controls of the caption editing panel include: theme 1 control, theme 2 control, and the customized caption theme control. When the user triggers the customized caption theme control in the caption editing panel, the fixed word description control and the caption style editing control as shown in FIG. 6(b) may be shown in the caption editing panel. A user can input one or more fixed words in a “fixed word input box”, for example, the user can input “street”; a user can input a style description sentence in a “caption style input box”, for example, the user can input “a kiss with high coldness, and write out the current scene state through a simple and powerful description with no more than ten words”; thus, at least one of fixed word or style description statements edited in at least one of the fixed word description control or the caption style editing control may be used as the content information.
S240, generating, in response to a triggering operation on a target control in the caption editing panel, target caption information associated with the media content based on the content information edited in the caption editing panel.
S250, presenting the media content and corresponding target caption information in the media content editing page.

In a technical solution of an embodiment of the present disclosure, a caption editing panel includes at least one caption theme, where the caption theme is configured to characterize a style of target caption information corresponding to a media content, and when content information is determined, the target caption theme corresponding to the media content can be determined in response to a triggering operation on the at least one layout theme in a caption editing panel, so as to determine the content information based on theme association information about the target layout theme. The technical solution of an embodiment of the present disclosure provides a plurality of optional topics and more detailed theme association information, which can automatically generate a corresponding style of caption for a specific scene, ensure that each topic has a high degree of fit with visual content, and can improve the richness of content information, thereby improving the richness of caption information.

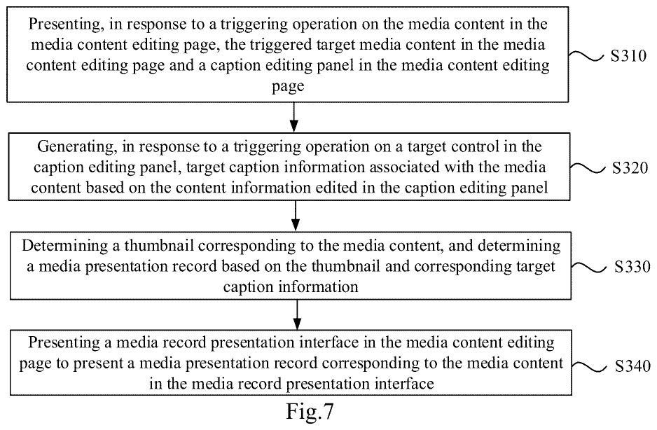

FIG. 7 is a schematic flow diagram of another method for generating caption information for media content according to an embodiment of the present disclosure. On the basis of the above-mentioned embodiments, the triggered target media content in technical solution of the present embodiment is presented in the media content editing page and the caption editing panel is presented in the media content editing page in detail, and the specific embodiments thereof can be seen from the detailed description of the embodiments of the present disclosure. The same or similar technical features as those of the previous embodiments will not be described in detail.

As shown in FIG. 7, the method of the present embodiment may specifically include:
S310, presenting, in response to a triggering operation on the media content in the media content editing page, a triggered target media content in the media content editing page and a caption editing panel in the media content editing page.
S320, generating, in response to a triggering operation on a target control in the caption editing panel, target caption information associated with the media content based on the content information edited in the caption editing panel.
S330, determining a thumbnail corresponding to the media content, and determining a media presentation record based on the thumbnail and the corresponding target caption information.

The thumbnail is a small-sized picture that performs compression processing on the media content. A media presentation record refers to a list for correspondingly presented thumbnails and caption information related to media content according to a preset presentation format.

Specifically, if the media content is a picture, zoom-out process can be performed on the media content according to a preset scaling method so as to obtain a thumbnail; and if the media content is a video, a target video frame (e.g. first video frame) can be determined from each video frame, and a zoom-out process is performed on the target video frame according to a preset scaling method so as to obtain a thumbnail. Accordingly, the thumbnails and corresponding target caption information can be typeset in a preset typesetting manner so as to obtain a media presentation record.

In the present embodiment, optionally, a specific implementation method for determining a thumbnail corresponding to a media content may include: in the case where the media content is an picture, the picture is reduced to obtain a thumbnail; in the case where the media content is a video, and the media content is not triggered, acquiring a target video frame in the video, and generating a thumbnail based on the target video frame, where the media content is video and the media content is in a triggered state, the triggered video frames are acquired and thumbnails are generated based on the video frames.

Specifically, if the media content is a picture, the thumbnail can be obtained by zooming out the picture by a preset size. If the media content is a video, and the media content is not triggered, at this moment, a target video frame can be determined from a plurality of video frames of the video, and then a thumbnail can be obtained by performing a reduction process on the target video frame according to a preset size. The determination method of the target video frame may include, but is not limited to, the following implementation methods: first, the first, the last, the middle or any one of the video frames in each video frame can be taken as a target video frame; second, a video frame satisfying a preset condition of picture quality can be screened as a target video frame through a preset video frame screening model, for example, the pre-video frame screening model can be a neural network model which is expected to be well trained. If the media content is a video, and the media content is in a triggered state, at this moment, the triggered video frame can be determined as a target video frame, and then the target video frame is reduced according to a preset size to obtain a thumbnail. In this embodiment, for different types and states of media content, corresponding thumbnail generation methods are respectively provided, improving the efficiency of thumbnail generation.
S340, presenting a media record presentation interface in the media content editing page to present a media presentation record corresponding to the media content in the media record presentation interface.

The media record presentation interface is a presentation interface for presenting a media presentation record.

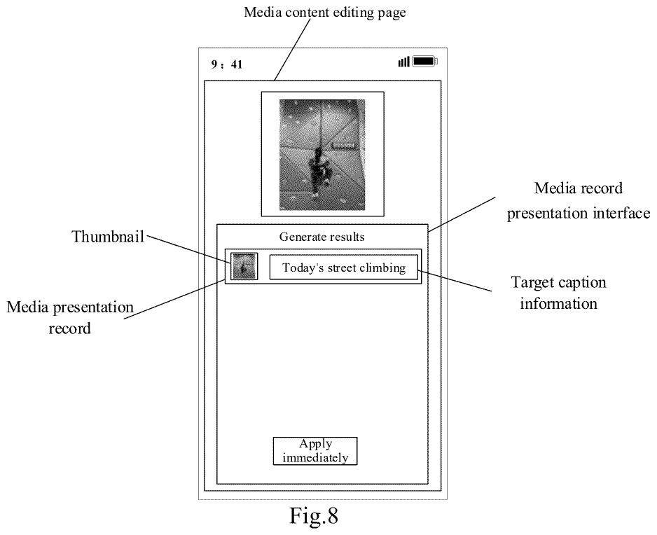

In this embodiment, upon completion of the media presentation record determination, a media record presentation interface may be presented in the media content editing page. A media presentation record corresponding to the media content can be presented in the media record presentation interface. On the basis of the above example, see FIG. 8 for a schematic diagram of a media presentation record in a media record presentation interface. As shown in FIG. 8, a media presentation record is presented in the media record presentation interface, and the media presentation record includes a thumbnail corresponding to the media content and target caption information (i.e., “today's street climbing”).

It can be understood that the number of pieces of media contents can be multiple, and the multiple pieces of media contents can be at least one of pictures or videos, and based on this, thumbnails and target caption information corresponding to each piece of media content can be determined, and a media presentation record corresponding to each piece of media content can be obtained, and thus multiple media presentation records can be presented in the media record presentation interface.

In the technical solution provided in the present embodiment, by presenting thumbnails and target caption information corresponding to various media contents in a media record presentation interface, a plurality of media presentation records can be presented clearly and orderly, and a user can clearly and clearly determine the target caption information corresponding to various media contents, which has a better viewing effect from a viewing angle and improves the user experience.

On the basis of the above-mentioned embodiments, a specific implementation method for presenting a media presentation record corresponding to a media content in the media record presentation interface may include: a target media presentation record (e.g. first media presentation record) corresponding to the target media content is presented at a first presentation position of the media record presentation interface, and the target media presentation record is in a selected state.

The selected state is used to characterize the target media content using the target caption information.

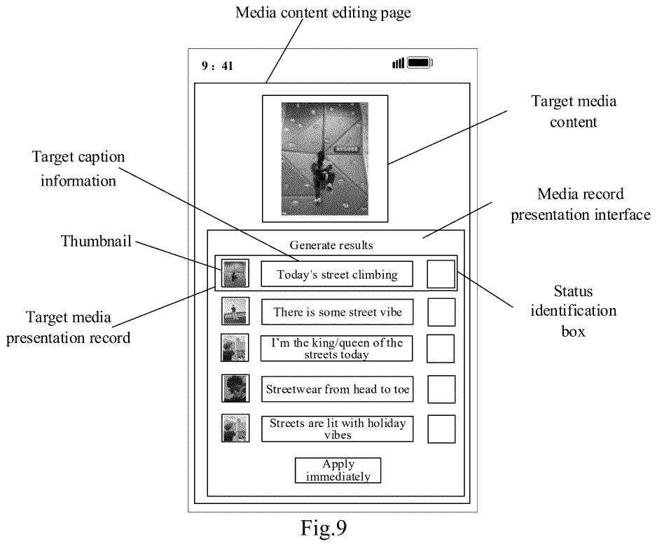

In the present embodiment, see FIG. 9 for a schematic diagram for presenting a plurality of media presentation records in a media record presentation interface for a case including a plurality of media contents. As shown in FIG. 9, a plurality of media presentation records are presented in the media record presentation interface, where the target media presentation record corresponding to the triggered target media content is presented at the first presentation position of the media record presentation interface. A state identification box used for indicating whether it is in a selected state is provided behind each media presentation record, and if the state identification box includes “✓”, the target caption information corresponding to the identified current state identification box is in the selected state; if “✓” is not included in the state identification box, the target caption information corresponding to the identified current state identification box is in an unselected state. For a target media presentation record, when presenting its target media presentation record, the state identification box corresponding thereto may be determined by default to include “✓”, indicating that the target media presentation record is in a selected state.

In particular, if the user does not want to enable the target media content to apply the target caption information, the user can click on the state identification box in the target media presentation record once to adjust the state identification box corresponding to the target media content to a state not including “✓”, indicating that the target caption information corresponding to the target media content is in an unselected state.

It can be understood that a user can determine whether to select corresponding target caption information by clicking a status identification box in each media presentation record in FIG. 9 once; and based on selecting one or several media presentation records, the user can click an “apply immediately” control, and a composite media content fused with the selected target caption information and the corresponding media content can be obtained at this time.

In the present embodiment, by presenting the target media presentation record at the first presentation position of the media record presentation interface, it is easier for the user to find the presentation position of the target media presentation record in the target page; and by means of the selection state information about the caption information, it is possible to clearly determine whether the selected state corresponds to the target caption information, so as to facilitate the subsequent operations of the user and improve the use experience of the user.

On the basis of the above-mentioned embodiments, in the case where at least one picture-in-picture is included in the media content, one media content corresponds to a plurality of different layers, a target presentation order (e.g. first presentation order) of the media presentation records corresponding to each layer in the media record presentation interface can be determined so as to improve the order of the media presentation records corresponding to the media content. The specific implementation method thereof may include: under the condition that the target media presentation record corresponding to the target media content is at the first presentation position, the target presentation order of the media presentation record corresponding to the media content in the media record presentation interface is determined according to the presentation layer of the media content in the media content editing page and the presentation time information in the presentation layer.

In this embodiment, if a media content includes one or more picture-in-pictures, a corresponding target caption content may be generated for each picture-in-picture at this time, and a media presentation record corresponding to each picture-in-picture may be determined, based on which the media content may correspond to a plurality of media presentation records. In this case, the target presentation order of each media presentation record in the media record presentation interface may be determined according to the presentation layer of the media content in the media content editing page and the presentation time information in the presentation layer, so as to present each media presentation record based on the target presentation order.

Illustratively, taking the media content as an picture for illustration, the main picture includes two picture-in-pictures, picture-in-picture 1 and picture-in-picture 2. One example: if the main picture corresponds to the main picture layer, picture-in-picture 1 corresponds to the second picture layer, and picture-in-picture 2 corresponds to the third picture layer, then the target presentation order can be represented as a first target media presentation record corresponding to the main picture, a second target media presentation record corresponding to picture-in-picture 1, and a third target media presentation record corresponding to picture-in-picture 2. Another example: the presentation time information corresponding to the main picture is T0-T5, the presentation time information corresponding to picture-in-picture 2 is T1-T3, and the presentation time information corresponding to picture-in-picture 1 is T2-T4, where T0<T1<T2<T3<T4<T5, then a target presentation order can be represented as a first target media presentation record corresponding to the main picture, a third target media presentation record corresponding to picture-in-picture 2, and a second target media presentation record corresponding to picture-in-picture 1.

With regard to the technical solution of the embodiments of the present disclosure, when media content and corresponding target caption information are presented in a media content editing page, a thumbnail corresponding to the media content can be determined; a media presentation record is determined based on the thumbnail and the corresponding target caption information; and a media record presentation interface is presented in the media content editing page so as to present the media presentation record corresponding to the media content in the media record presentation interface. With regard to the technical solution of the embodiments of the present disclosure, by presenting thumbnails and target caption information corresponding to various media contents in a media record presentation interface, a plurality of media presentation records can be presented clearly and orderly, and a user can clearly determine target caption information corresponding to various media contents, which has a better viewing effect from a viewing angle, and improves the user experience.

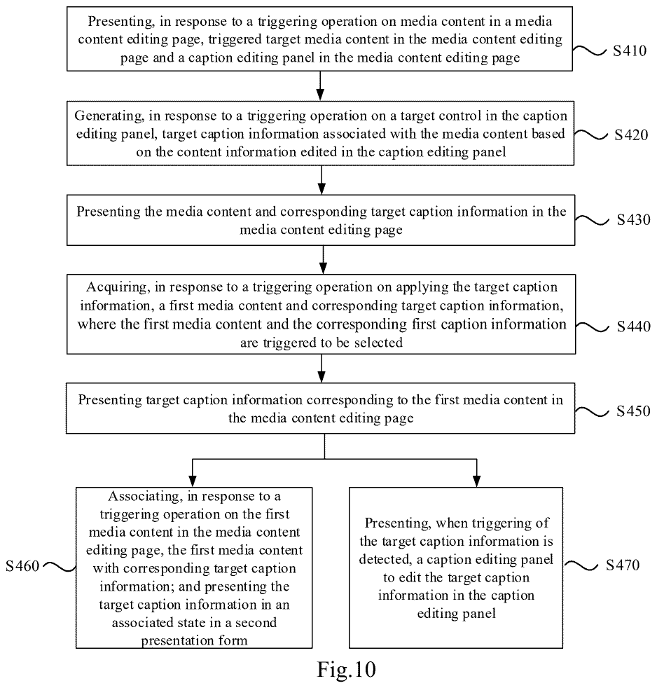

FIG. 10 is a schematic flow diagram of another method for generating caption information for media content according to an embodiment of the present disclosure. On the basis of the above-mentioned embodiments, the technical solution of the present embodiment can also acquire the first media content which is triggered to be selected and the corresponding target caption information in response to the triggering operation on the application target caption information, so as to present the target caption information corresponding to the first media content in the media content editing page, and further can associate the first media content with the corresponding target caption information in response to the triggering operation on the first media content in the media content editing page, and present the target caption information in an associated state in a second presentation form, and a caption editing panel can also be presented when triggering target caption information is detected, so as to edit the target caption information in the caption editing panel, and how to present corresponding sub-texts differently according to a presentation time stamp in the target information is described in detail, and the particular embodiments thereof can be seen from the detailed description of the embodiments of the present disclosure. The same or similar technical features as those of the previous embodiments will not be described in detail.

As shown in FIG. 10, the method of the present embodiment may specifically include:
S410, presenting, in response to a triggering operation on media content in a media content editing page, triggered target media content in the media content editing page, and presenting a caption editing panel in the media content editing page.
S420, generating, in response to a triggering operation on a target control in the caption editing panel, target caption information associated with the media content based on the content information edited in the caption editing panel.
S430, presenting the media content and the corresponding target caption information in the media content editing page.
S440, acquiring, in response to a triggering operation on applying the target caption information, first media content and corresponding target caption information, where the first media content and the corresponding first caption information are triggered to be selected.

The first media content is content in the media content. The first media content is the media content for which target caption information has been selected and is about to be applied.

In the present embodiment, an application control is further included in a media content editing page, and when a user selects one or several pieces of target caption information from the media content editing page, the application control is clicked, and at this moment, the media content corresponding to the selected target caption information is the first media content, and the target caption information which is triggered to be selected and the first media content corresponding to these target caption information can be acquired.
S450, presenting target caption information corresponding to the first media content in the media content editing page.

In the present embodiment, the target caption information corresponding to the first media content can be presented in a preset presentation form in the media content editing page. For example, the preset presentation form may be that the first media content and the corresponding target caption information are presented in a specified caption presentation area; the first media content and corresponding target caption information, etc. are presented in a media content preview area. In this embodiment, through the triggering operation of the one-touch application, the target caption information and the first media content selected by the user can be presented, and the text and the media content can be internally associated, so as to enhance the overall aesthetic sense and visual sense.

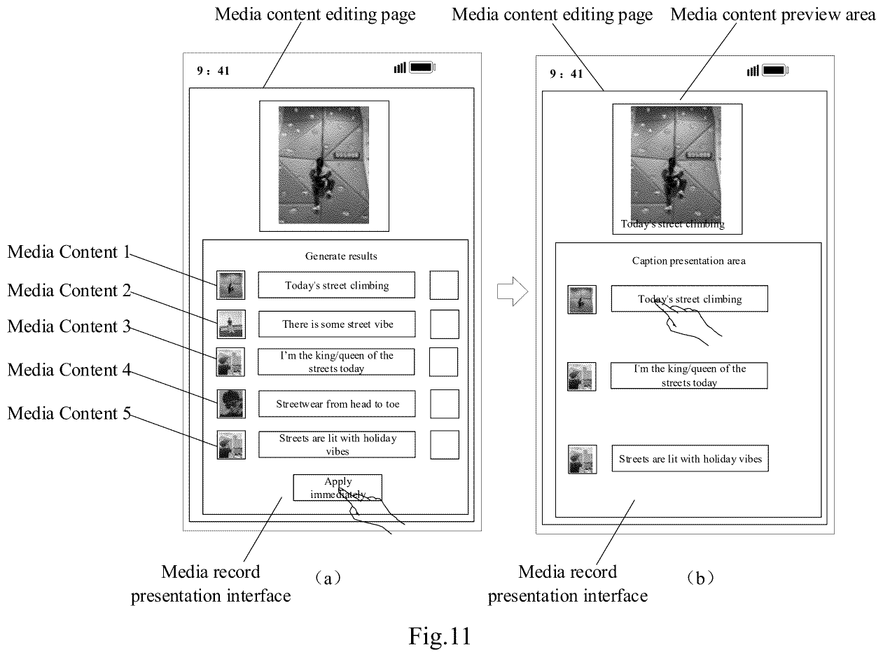

Illustratively, see FIG. 11 for a schematic diagram of the presentation process for target caption information corresponding to first media content.

As shown in FIG. 11(a), the target caption information corresponding to the media content 1 in the media record presentation interface, the target caption information corresponding to the media content 3 and the target caption information corresponding to the media content 5 correspond to the selected state, and at this moment, the user triggers the “apply immediately” control in the page, and at this moment, the media content 1, the media content 3 and the media content 5 in the media record presentation interface are the first media content. As shown in FIG. 11(b), a media content 1, a media content 3, a media content 5 and target caption information respectively corresponding thereto can be presented in a text presentation area of a media record presentation interface; and when a user triggers at least one of a thumbnail corresponding to the media content 1 or corresponding target caption information, the media content 1 and the corresponding target caption information can be presented in a media content preview area.

Based on the above embodiments, a media content presentation track is included in the media content editing page, and the media content presentation track includes at least one slot, where each slot corresponds to one piece of media content. A slot may be understood as a data slot that is generated from the first material added when making the media content template and that may be used to add custom material (which may be the first material or other material). The presentation duration corresponding to each slot position can be adjusted according to the user's operation.

On this basis, the specific implementation method of presenting the target caption information corresponding to the first media content in the media content editing page may further include: a text track is presented at a slot corresponding to the first media content, so as to present target caption information about the first media content in the text track.

The text track refers to a track used for bearing the target caption information. The presentation length of the text track corresponds to the length of the slot carrying the first media content. The target caption information is presented in a first modality on a media content editing page.

In the present embodiment, a text track having the same length as the corresponding slot of the first media content may be presented at an associated position of each corresponding slot of the first media content, for example, the associated position may be directly below the corresponding slot of the first media content, so that the corresponding target caption information thereof may be presented on the text track. As such, the media content presentation tracks and text tracks are logically arranged such that the media content clips are more ordered and the readability and suitability for reading of the media content is improved.

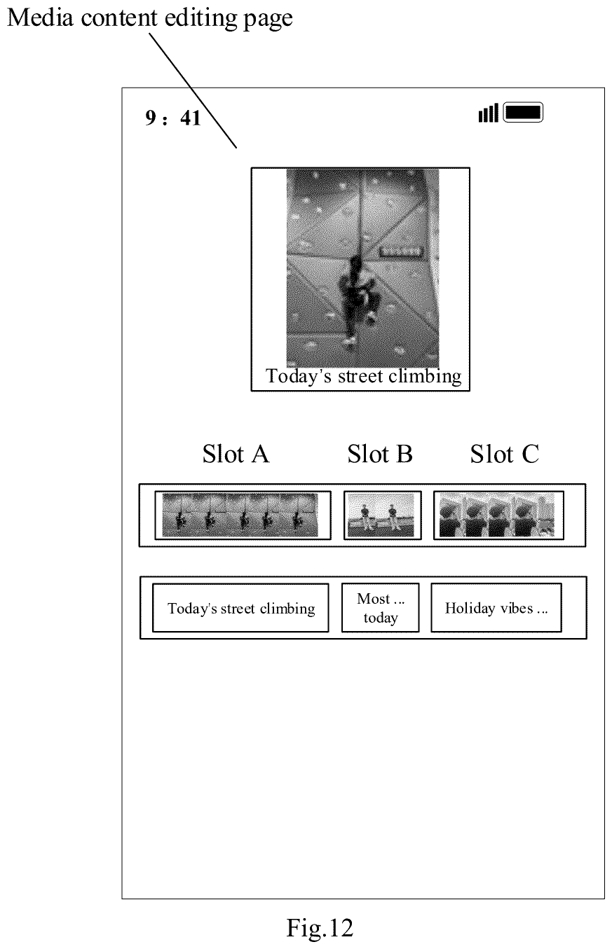

On the basis of the above example, see FIG. 12 for a schematic diagram of a media content presentation track and a corresponding text track. As shown in FIG. 12, the media content presentation track includes three slots, which are respectively: slot A corresponding to media content 1, slot B corresponding to media content 3, and slot C corresponding to media content 5. Based on this, a first text track with the same length as the slot A can be presented directly below the slot A, and the first text track is used for presenting the target caption content “Today's street climbing” of the media content 1; a second text track with the same length as the slot position B can be presented directly below the slot position B, and the second text track is used for presenting the target caption content of the media content 3, “I'm the king/queen of the streets today”; a third text track with the same length as the slot C can be presented directly below the slot C, and the third text track is used for presenting the target caption content of the media content 5, “Streets are lit with holiday vibes”. In particular, when a user triggers a deletion control corresponding to a certain slot position, a prompt character that a text track corresponding to the slot position will also be deleted can be popped up.
S460, associating, in response to a triggering operation on the first media content in the media content editing page, the first media content with corresponding target caption information; and presenting the target caption information in an associated state in a second presentation form.

The second presentation form is different from the first presentation form. For example, the first presentation form is that the text colour of the target caption information is black, and the second presentation form is that the text colour of the target caption information is red; the text box with the first presentation form being the target caption information is a semi-transparent filling colour, and the text box with the second presentation form being the target caption information is a semi-transparent grey filling colour, etc.

In the present embodiment, when a user triggers any first media content in a media content editing page, association processing can be performed on the first media content and corresponding target caption information, and furthermore, the target caption information about the first media content can be presented differently in a second presentation form. In this way, when a user triggers a certain first media content, target caption information corresponding thereto can be presented differently, and the user can know the target caption information corresponding to the current first media content, facilitating further operation and processing, and improving the user's usage experience.

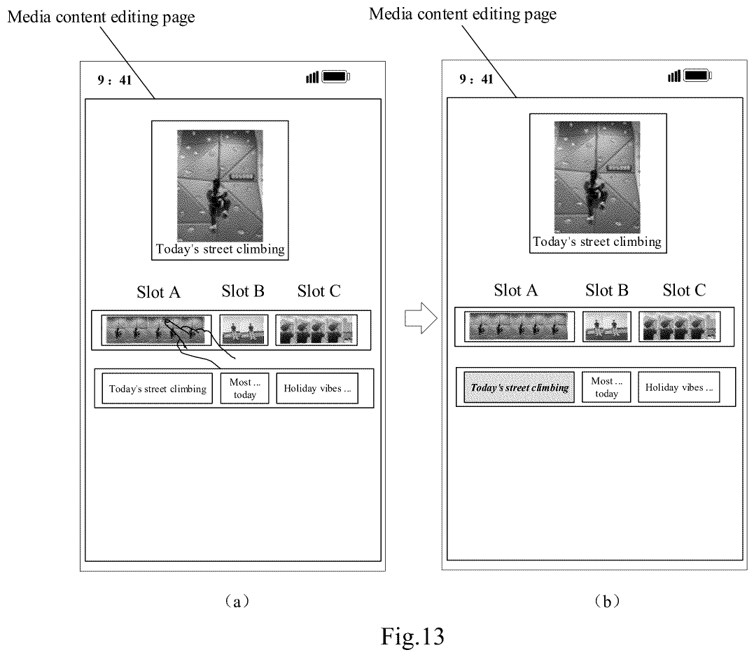

On the basis of the above example, see FIG. 13 for a schematic diagram of a process for presenting the target caption information in the second presentation form. As shown in FIG. 13(a), when a user clicks on media content 1 in slot A, the text presentation form of the target caption information “Today's street climbing” corresponding to the media content 1 is: the bold italicized text and text box is a translucent gray fill color.
S470, presenting, when triggering of the target caption information is detected, a caption editing panel to edit the target caption information in the caption editing panel.

In the present embodiment, the caption editing panel may be presented when the user triggers the target caption information. The caption editing panel includes at least one text editing control used for editing and processing the caption information, and these text editing controls include, but are not limited to, a pattern editing control, a text font editing control, a color editing control, a transparency editing control, etc. and also include a copy editing control, a delete editing control, etc. The user can edit the target caption information by triggering these editing controls. The purpose of this setting is that, through the caption editing panel, the user can individually adjust the content of the caption presentation according to the user's needs, so as to improve the interaction between the user and the presentation page and satisfy the user's individual requirements.

With regard to the technical solution of the embodiments of the present disclosure, after the media content and corresponding target caption information are presented in the media content editing page, the first media content and the corresponding target caption information that are triggered to be selected can also be acquired in response to a triggering operation on the application of the target caption information, so that the target caption information corresponding to the first media content is presented in the media content editing page; the target caption information and the first media content selected by the user can be presented through a triggering operation of a one-click application, and the text can form an intrinsic association with the media content, so as to enhance the overall aesthetics and vision. In addition, in response to a triggering operation on the first media content in the media content editing page, the first media content can also be associated with corresponding target caption information; and presenting the target caption information in an associated state in a second presentation form, and when a user triggers a certain first media content, the target caption information corresponding thereto can be presented differently, and the user can know the target caption information corresponding to the current first media content, facilitating further operation processing, and improving the user's usage experience. In addition, when the trigger target caption information is detected, the caption editing panel is presented so as to edit the target caption information in the caption editing panel, and the text presentation content can be adjusted personalized according to the user's needs, so as to improve the user's interaction with the presentation page and satisfy the user's personalized requirements.

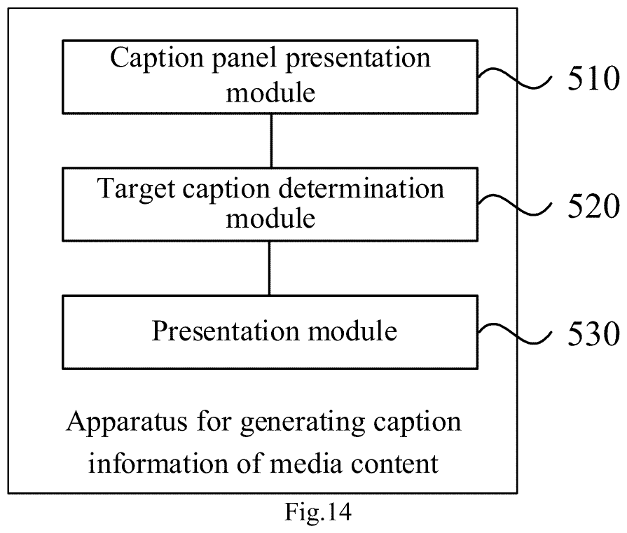

FIG. 14 is a schematic structure diagram of an apparatus for generating caption information for media content according to an embodiment of the present disclosure, and as shown in FIG. 14, the apparatus includes: a caption panel presentation module 510, a target caption determination module 520, and a presentation module 530.

The caption panel presentation module 510 is used for presenting, in response to a triggering operation on media content in a media content editing page, triggered target media content in the media content editing page and a caption editing panel in the media content editing page;
the target caption determination module 520 is used for generating, in response to a triggering operation on a target control in the caption editing panel, target caption information associated with the media content based on the content information edited in the caption editing panel;
the presentation module 530 is used for presenting the media content and corresponding target caption information in the media content editing page.

On the basis of each of the above-mentioned optional technical solutions, optionally, the caption editing panel includes at least one caption theme, where the caption theme is configured to characterize a style of target caption information corresponding to the media content, and a media content generating caption information apparatus further includes: a constraint content determination module; and the constraint content determination module includes:
a caption theme determination unit, for determining, in response to a triggering operation on the at least one caption theme in the caption editing panel, a target caption theme corresponding to the media content;
a constraint content determination unit, for determining the content information based on the theme association information of the target caption theme.

On the basis of each of the above-mentioned optional technical solutions, optionally, the at least one type of caption theme includes a customized caption theme, and based on theme association information of the target caption theme, a caption theme determination unit is specifically used for presenting a fixed word description control and a caption style editing control in the caption editing panel in response to a triggering operation on the customized caption theme in the caption editing panel; taking the theme association information edited in at least one of the fixed word description control or the caption style editing control as the content information; where a fixed word edited in the fixed word description control is the word that needs to be included in generating the target caption information.

On the basis of each of the above-mentioned optional technical solutions, optionally, a target caption determination module 520 includes:
a presentation record determination unit, for determining a thumbnail corresponding to the media content, and determining a media presentation record based on the thumbnail and corresponding target caption information;
a presentation record presentation unit, for presenting a media record presentation interface in the media content editing page to present a media presentation record corresponding to the media content in the media record presentation interface.

On the basis of each of the above-mentioned optional technical solutions, optionally, a presentation record presentation unit, specifically for presenting a target media presentation record corresponding to the target media content at a first presentation position of the media record presentation interface, and the target media presentation record being in a selected state, where the selected state is configured to characterize that the target media content uses the target caption information.

On the basis of each of the above-mentioned optional technical solutions, optionally, the target caption determination module 520 further includes: a presentation order determination unit;
the presentation order determination unit is used for determining, according to a presentation layer of the media content in the media content editing page and presentation time information in the presentation layer under the condition that a target media presentation record corresponding to the target media content is at a first presentation position, a target presentation order of a media presentation record corresponding to the media content in the media record presentation interface.

On the basis of the above-mentioned optional technical solutions, optionally, the presentation record determination unit further includes: a thumbnail determination unit;
the thumbnail determination unit is used for, in the case where the media content is an picture, reducing the picture to obtain the thumbnail; in the case where the media content is a video and the media content is not triggered, acquiring a target video frame in the video, and generating the thumbnail based on the target video frame; in the case where the media content is a video and the media content is triggered, acquiring a triggered video frame, and generating the thumbnail based on the video frame.

On the basis of each of the above-mentioned optional technical solutions, optionally, a media content generation caption information apparatus further includes: a target caption presentation module;
a target caption determination unit, for acquiring, in response to a triggering operation on applying the target caption information, a first media content and corresponding target caption information, where the first media content and the corresponding first caption information are triggered to be selected;
a target caption presentation unit, for presenting target caption information corresponding to the first media content in the media content editing page, where the first media content is content in the media content.

On the basis of each of the above-mentioned optional technical solutions, it is optional that the media content editing page includes a media content presentation track, the media content presentation track includes at least one slot, and the slot corresponds to one media content; a target caption presentation unit, specifically for presenting a text track at a slot corresponding to the first media content, so as to presentation target caption information of the first media content in the text track; where the presentation length of the text track is consistent with the length of a slot carrying the first media content.

On the basis of each of the above-mentioned optional technical solutions, optionally, a media content generation caption information apparatus further includes: a caption editing module;
a caption editing module, for presenting, when triggering of the target caption information is detected, a caption editing panel to edit the target caption information in the caption editing panel.

On the basis of each of the above-mentioned optional technical solutions, optionally, a media content generation caption information apparatus further includes: a target caption association module;
a target caption association module, for associating, in response to a triggering operation on the first media content in the media content editing page, the first media content with corresponding target caption information; and presenting the target caption information in an associated state in a second presentation form.

A technical solution of an embodiment of the present disclosure, in response to a triggering operation on media content in a media content editing page, presenting a triggered target media content in the media content editing page a caption editing panel in the media content editing page; generating, in response to a triggering operation on a target control in the caption editing panel, target caption information associated with the media content based on the content information edited in the caption editing panel; presenting the media content and corresponding target caption information in the media content editing page. In the technical solution of the embodiments of the present disclosure, a user can quickly edit content information satisfying personalized requirements via a caption editing panel, thereby automatically generating a high-quality caption, improving the efficiency of caption generation, satisfying multiple requirements of a user on the fit degree and expressiveness of the caption content, and improving the user's interaction enthusiasm.

The apparatus for generating caption information for media content provided in the embodiments of the present disclosure can perform the method for generating caption information for media content provided in any of the embodiments of the present disclosure, and has corresponding functional modules and advantageous effects for performing the method.

It should be noted that the various units and modules included in the above-mentioned apparatus are merely divided according to functional logic, but are not limited to the above-mentioned division, as long as corresponding functions can be realized; In addition, the specific names of the functional units are merely for the convenience of distinguishing each other and are not intended to limit the scope of protection of the embodiments of the present disclosure.

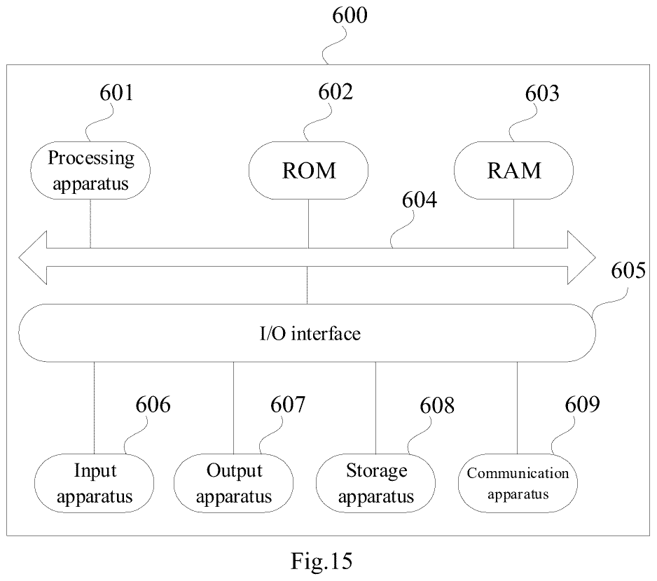

FIG. 15 is a schematic diagram illustrating the structure of an electronic device according to an embodiment of the present disclosure. Reference is now made to FIG. 15, which illustrates a block schematic diagram of an electronic device (e.g., a terminal device or a server in FIG. 15) 600 suitable for implementing an embodiment of the present disclosure. The terminal device in the embodiment of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (e.g. an in-vehicle navigation terminal), etc. and a fixed terminal such as a digital TV, a desktop computer, etc. The electronic device shown in FIG. 15 is merely an example and should not pose any limitation on the scope of use or functionality of embodiments of the present disclosure.

As shown in FIG. 15, the electronic device 600 may include a processing apparatus (e.g. central processing unit, graphics processor, etc.) 601 that may perform various suitable actions and processes according to a program stored in a read-only memory (ROM) 602 or a program loaded from a storage apparatus 608 into a random access memory (RAM) 603. In the RAM 603, various programs and data necessary for the operation of the electronic device 600 are also stored. The processing apparatus 601, the ROM 602, and the RAM 603 are connected to each other via a bus 604. An edit/output (I/O) interface 605 is also coupled to bus 604.

In general, the following apparatus may be connected to the I/O interface 605: input apparatus 606 including, for example, touch screens, touch pads, keyboards, mice, cameras, microphones, accelerometers, gyroscopes, and the like; output apparatus 607 including, for example, a liquid crystal display (LCD), a speaker, a vibrator, etc.; storage apparatus 608 including, for example, a magnetic tape, a hard disk, etc.; and a communication apparatus 609. The communication apparatus 609 may allow the electronic device 600 to communicate wirelessly or wiredly with other devices to exchange data. Although FIG. 15 illustrates an electronic device 600 having various apparatus, it should be understood that not all of the illustrated apparatus are required to be implemented or provided. More or fewer apparatus may alternatively be implemented or provided.

In particular, the processes described above with reference to flow diagrams may be implemented as computer software programs according to embodiments of the present disclosure. For example, embodiments of the present disclosure include a computer program product including a computer program embodied on a non-transitory computer-readable medium, the computer program containing program code for performing the methods illustrated in the flowcharts. In such an embodiment, the computer program may be downloaded and installed from a network via communication apparatus 609, or from storage apparatus 608, or from the ROM 602. When the computer program is performed by the processing apparatus 601, the above-described functions defined in the method of the embodiment of the present disclosure are performed.

The names of messages or information that are interacted between apparatuses in embodiments of the present disclosure are for illustrative purposes only and are not intended to limit the scope of such messages or information.

An electronic device provided by an embodiment of the present disclosure belongs to the same inventive concept as a method for generating caption information for media content provided by the above-mentioned embodiment, technical details that are not described in detail in the embodiment of the present disclosure can be found in the above-mentioned embodiment, and the present embodiment has the same advantageous effects as the above-mentioned embodiment.

An embodiment of the present disclosure provides a computer storage medium having stored thereon a computer program which, when performed by a processor, performs the method for generating caption information for media content provided in the above-mentioned embodiment.

Note that the computer-readable medium described above in the present disclosure can be either a computer-readable signal medium or a computer-readable storage medium, or any combination of the two. The computer-readable storage medium can be, for example, but not limited to, an electronic, magnetic, optical, electromagnetic, infrared, or semiconductor system, apparatus, or device, or a combination of any of the above. More specific examples of a computer-readable storage medium may include, but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program that can be used by or in connection with an instruction execution system, apparatus, or device. In the present disclosure, a computer-readable signal medium may include a data signal embodied in baseband or propagated as part of a carrier wave having computer-readable program code embodied therein. Such a propagated data signal may take many forms, including but not limited to electromagnetic signals, optical signals, or any suitable combination of the preceding. The computer-readable signal medium can also be any computer-readable medium other than a computer-readable storage medium that can send, propagate, or transport the program for use by or in connection with the instruction execution system, apparatus, or device. The program code embodied on the computer-readable medium may be transmitted over any suitable medium, including, but not limited to: wire, fiber optic cable, RF (radio frequency), and the like, or any suitable combination of the foregoing.

In some implementations, the client, server may communicate using any currently known or future developed network protocol, such as HTTP (Hyper Text Transfer Protocol), and may be interconnected with any form or medium of digital data communication (e.g., a communication network). Examples of communication networks include a local area network (“LAN”), a wide area network (“WAN”), an Internet network (e.g., the Internet), and a peer-to-peer network (e.g., an ad hoc peer-to-peer network), as well as any currently known or future developed network.

The computer-readable medium may be one contained in the electronic device; it may also be a stand-alone device that is not incorporated into the electronic device.

The above-mentioned computer-readable medium carries one or more programs, and when the above-mentioned one or more programs are performed by the electronic device, the electronic device is caused to: presenting, in response to a triggering operation on a media content in a media content editing page, triggered target media content in the media content editing page and a caption editing panel in the media content editing page; generating, in response to a triggering operation on a target control in the caption editing panel, target caption information associated with the media content based on the content information edited in the caption editing panel; presenting the media content and corresponding target caption information in the media content editing page.

Computer program code for performing operations of the present disclosure may be written in one or more programming languages, including, but not limited to, object-oriented programming languages, such as Java, Smalltalk, C++, and conventional procedural programming languages, such as the “C” language or similar programming languages, or a combination thereof. The program code may be performed entirely on the user's computer, partly on the user's computer, as a stand-alone software package, partly on the user's computer and partly on a remote computer or entirely on the remote computer or server. In the case of a remote computer, the remote computer may be connected to the user's computer through any type of network, including a local area network (LAN) or a wide area network (WAN), or it may be connected to an external computer (e.g. through the Internet using an Internet Service Provider).

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It should also be noted that in some alternative implementations, the functions noted in the blocks may occur out of the order noted in the figures. For example, two blocks shown in succession may in fact be performed substantially in parallel, or the blocks may sometimes be performed in the reverse order, depending upon the functionality involved. It will also be noted that each block of at least one of the block diagrams or the flowchart illustrations, and combinations of blocks in at least one of the block diagrams or the flowchart illustrations, can be implemented by special purpose hardware-based systems that perform the specified functions or operations, or combinations of special purpose hardware and computer instructions.

The elements described in connection with the embodiments disclosed herein may be implemented in software or hardware. The name of an element does not in any way constitute a limitation on the element itself.

The functions described herein above may be performed, at least in part, by one or more hardware logic components. For example, and not by way of limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination of the preceding. More specific examples of a machine-readable storage medium would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the preceding.

The foregoing description is only a preferred embodiment of the present disclosure and is illustrative of the principles of the technology employed. It will be appreciated by those skilled in the art that the scope of the present disclosure is not limited to any particular combination of the features described above, but is intended to cover other combinations of the features described above or their equivalents without departing from the spirit of the disclosure. For example, the above-mentioned features and the technical features disclosed in the present disclosure (but not limited to) having similar functions may be replaced with each other to form a technical solution.

Further, although operations are depicted as being performed in a particular order, this should not be understood as requiring that the operations be performed in the particular order shown or in sequential order. Under certain circumstances, multitasking and parallel processing may be advantageous. As such, while several implementation details have been included in the above discussion, these should not be construed as limiting the scope of the present disclosure. Certain features that are described in the context of separate embodiments may also be implemented in combination in a single embodiment. Conversely, various features that are described in the context of a single embodiment can also be implemented in multiple embodiments separately or in any suitable subcombination.

Although the subject matter has been described in language specific to at least one of structural features or methodological acts, it is to be understood that the subject matter defined in the appended claims is not necessarily limited to the specific features or acts described above. Rather, the specific features and acts described above are merely exemplary forms of implementing the claims.

1. A method for generating caption information for media content, comprising:
presenting, in response to a triggering operation on media content in a media content editing page, the triggered second media content in the media content editing page and a caption editing panel in the media content editing page;
generating, in response to a triggering operation on a first control in the caption editing panel, first caption information associated with the media content based on content information edited in the caption editing panel; and
presenting the media content and the first caption information in the media content editing page.

2. The method of claim 1, wherein the caption editing panel comprises at least one caption theme, the at least one caption theme is configured to characterize a style of the first caption information corresponding to the media content, and the method further comprises:
determining, in response to a triggering operation on the at least one caption theme in the caption editing panel, a first caption theme corresponding to the media content; and
determining the content information based on theme association information of the first caption theme.

3. The method of claim 2, wherein the at least one caption theme comprises a customized caption theme, and the determining the content information based on the theme association information of the first caption theme comprises:
presenting, in response to a triggering operation on the customized caption theme in the caption editing panel, a fixed word description control and a caption style editing control in the caption editing panel; and
taking the theme association information edited in at least one of the fixed word description control or the caption style editing control as the content information,
wherein a fixed word edited in the fixed word description control is a word that needs to be included in generating the first caption information.

4. The method of claim 1, wherein the presenting the media content and the first caption information in the media content editing page, comprises:
determining a thumbnail corresponding to the media content, and determining a media presentation record based on the thumbnail and the first caption information; and
presenting a media record presentation interface in the media content editing page to present the media presentation record corresponding to the media content in the media record presentation interface.

5. The method of claim 4, wherein the presenting the media presentation record corresponding to the media content in the media record presentation interface, comprises:
presenting a first media presentation record corresponding to the second media content at a first presentation position of the media record presentation interface, and the first media presentation record being in a selected state,
wherein the selected state is configured to characterize that the second media content uses the first caption information.

6. The method of claim 5, further comprising:
determining, according to a presentation layer of the media content in the media content editing page and presentation time information in the presentation layer under a condition that the first media presentation record corresponding to the second media content is at a first presentation position, a first presentation order of the media presentation record corresponding to the media content in the media record presentation interface.

7. The method of claim 4, wherein the determining the thumbnail corresponding to the media content comprises:
reducing, in response to the media content being a picture, the picture to obtain the thumbnail;
acquiring, in response to the media content being a video and the media content is not triggered, a first video frame in the video, and generating the thumbnail based on the first video frame; and
acquiring, in response to the media content being a video and the media content is triggered, a triggered video frame, and generating the thumbnail based on the video frame.

8. The method of claim 1, wherein after the presenting the media content and the first caption information in the media content editing page, the method further comprises:
acquiring, in response to a triggering operation on applying the first caption information, first media content and a corresponding first caption information, wherein the first media content and the corresponding first caption information are triggered to be selected; and
presenting first caption information corresponding to the first media content in the media content editing page,
wherein the first media content is content in the media content.

9. The method of claim 8, wherein the media content editing page comprises a media content presentation track, the media content presentation track comprises at least one slot, the slot corresponds to one piece of media content, and the presenting the first caption information corresponding to the first media content in the media content editing page, comprises:
presenting a text track at a slot corresponding to the first media content, so as to present first caption information of the first media content in the text track,
wherein a presentation length of the text track is consistent with a length of a slot carrying the first media content.

10. The method of claim 8, further comprising:
presenting, in response to triggering of the first caption information being detected, the caption editing panel to edit the first caption information in the caption editing panel.

11. The method of claim 8, further comprising:
associating, in response to a triggering operation on the first media content in the media content editing page, the first media content with the corresponding first caption information; and
presenting the first caption information in an associated state in a second presentation form.

12. An electronic device, comprises:
one or more processors; and
a storage apparatus, for storing one or more programs,
wherein the one or more programs are executed by the one or more processors, and cause the one or more processors to:
present, in response to a triggering operation on media content in a media content editing page, the triggered second media content in the media content editing page and a caption editing panel in the media content editing page;
generate, in response to a triggering operation on a first control in the caption editing panel, first caption information associated with the media content based on content information edited in the caption editing panel; and
present the media content and the first caption information in the media content editing page.

13. The electronic device of claim 12, wherein the caption editing panel comprises at least one caption theme, the at least one caption theme is configured to characterize a style of the first caption information corresponding to the media content, and the one or more processors are further caused to:
determine, in response to a triggering operation on the at least one caption theme in the caption editing panel, a first caption theme corresponding to the media content; and
determine the content information based on theme association information of the first caption theme.

14. The electronic device of claim 13, wherein the at least one caption theme comprises a customized caption theme, and the one or more processors are further caused to:
present, in response to a triggering operation on the customized caption theme in the caption editing panel, a fixed word description control and a caption style editing control in the caption editing panel; and
take the theme association information edited in at least one of the fixed word description control or the caption style editing control as the content information,
wherein a fixed word edited in the fixed word description control is a word that needs to be included in generating the first caption information.

15. The electronic device of claim 12, wherein the one or more processors are further caused to:
determine a thumbnail corresponding to the media content, and determine a media presentation record based on the thumbnail and the first caption information; and
present a media record presentation interface in the media content editing page to present the media presentation record corresponding to the media content in the media record presentation interface.

16. The electronic device of claim 15, wherein the one or more processors are further caused to:
present a first media presentation record corresponding to the second media content at a first presentation position of the media record presentation interface, and the first media presentation record being in a selected state,
wherein the selected state is configured to characterize that the second media content uses the first caption information.

17. The electronic device of claim 15, wherein the one or more processors are further caused to:
determine, according to a presentation layer of the media content in the media content editing page and presentation time information in the presentation layer under a condition that the first media presentation record corresponding to the second media content is at a first presentation position, a first presentation order of the media presentation record corresponding to the media content in the media record presentation interface.

18. The electronic device of claim 15, wherein the one or more processors are further caused to:
reduce, in response to the media content being a picture, the picture to obtain the thumbnail;
acquire, in response to the media content being a video and the media content is not triggered, a first video frame in the video, and generate the thumbnail based on the first video frame; and
acquire, in response to the media content being a video and the media content is triggered, a triggered video frame, and generate the thumbnail based on the video frame.

19. The electronic device of claim 12, wherein after the presenting the media content and the first caption information in the media content editing page, the one or more processors are further caused to:
acquire, in response to a triggering operation on applying the first caption information, first media content and a corresponding first caption information, wherein the first media content and the corresponding first caption information are triggered to be selected; and
present first caption information corresponding to the first media content in the media content editing page,
wherein the first media content is content in the media content.

20. A non-transitory computer-readable storage medium comprising computer-executable instructions, wherein the computer-executable instructions, when executed by a computer processor, cause the processor to:
present, in response to a triggering operation on media content in a media content editing page, the triggered second media content in the media content editing page and a caption editing panel in the media content editing page;
generate, in response to a triggering operation on a first control in the caption editing panel, first caption information associated with the media content based on content information edited in the caption editing panel; and
present the media content and the first caption information in the media content editing page.
